(19) United States
(12) Patent Application Publication
(10) Pub. No.: US 2007/0083554 A1
(43) Pub. Date: Apr. 12, 2007

(54) Visual role definition for identity management

(75) Inventor: Jeffery L. Crume, Raleigh, NC (US)

Correspondence Address: HOFFMAN, WARNICK & D'ALESSANDRO LLC, 75 STATE ST, 14 FL, ALBANY, NY, 12207, US

(73) Assignee: International Business Machines Corporation, Armonk, NY (US)

(21) Appl. No.: 11/248,715

(22) Filed: Oct. 12, 2005

(51) Int. Cl. G06F 17/00

(52) U.S. Cl. 707/104.1

(57) ABSTRACT

An identity management system and method having a graphical user interface for manipulating graphical role data. Included is a system for graphically defining roles in an organization; a system for graphically defining relationships among the roles in the organization; and a system for graphically assigning rights to different roles in the organization. The relationships among the roles are implemented by applying inheritance rules in, e.g., a hierarchical fashion

### BACKGROUND OF THE INVENTION

1. Technical Field

The present invention relates generally to identity management, and more specifically relates to a system and method for using visual role definitions for implementing an identity management system.

2. Related Art

As enterprises become more and more complex, controlling access to information for the various users becomes more and more challenging. This field of endeavor, commonly referred to as “identity management,” is responsible for such things as automating the provisioning of user accounts and privileges within an enterprise. One of the most difficult and time-consuming aspects of an enterprise-scale identity management project involves defining a set of user roles that adequately represent the needs of the organization. Typically, this task involves a great deal of manual effort to discover what access rights exist, what rights are needed for each different job type and how to determine reasonable role groupings from this information. For instance, in an organization, all employees may require an email account and basic network access, management may require additional data access privileges, accountants and executive level employees may require access to financial data, senior executives and human resources may require access to employee records, etc.

Present day systems often utilize directory based data formats that dictate what access rights and privileges are to be given to which users/roles within the organization. Existing directory based data specifications, such as DSML (Directory Services Markup Language) and LDIF (Lightweight Directory Interchange Format), can be used to provide structured definitions for capturing and storing identity management data. Unfortunately, few present day tools exist which allow identity management data stored in these formats to be presented and manipulated by an end user in an intuitive fashion. Accordingly, a need exists for a tool that would more intuitively represent relationships and privileges for different roles within an organization and better facilitate the creation of these definitions.

### SUMMARY OF THE INVENTION

The present invention addresses the above-mentioned problems, as well as others, by providing an identity management tool that includes a graphical user interface that provides a visual, mind mapping interface that graphically represents and defines relationships and rights for various roles in an organization. The interface allows roles to be defined as nodes in a tree-like structure in which rights can be passed between different roles based on relationships defined among the roles. The relationships are implemented using inheritance rules in which rights granted to a first role automatically flow to a second role.

In a first aspect, the invention provides an identity management system having a graphical user interface for manipulating graphical role data, comprising: a system for graphically defining roles in an organization; a system for graphically defining relationships among the roles in the organization; and a system for graphically assigning rights to different roles in the organization.

In a second aspect, the invention provides a computer program product stored on a computer usable medium for processing organizational roles with a graphical user interface that can manipulate graphical role data, comprising: program code configured to allow a user to graphically define roles in an organization; program code configured to allow a user to graphically define relationships among the roles in the organization; and program code configured to allow a user to graphically assign rights to different roles in the organization.

In a third aspect, the invention provides a method for processing organizational roles with a graphical user interface that can manipulate graphical role data, comprising: graphically defining roles in an organization as nodes in a tree-like structure; graphically defining relationships among the roles in the organization with arrows; and graphically assigning rights to different roles in the organization.

In a fourth aspect, the invention provides a method for deploying an application for processing organizational roles with a graphical user interface that can manipulate graphical role data, comprising: a computer infrastructure being operable to: allow a user to graphically define roles in an organization; allow a user to graphically define relationships among the roles in the organization; and allow a user to graphically assign rights to different roles in the organization.

In a fifth aspect, the invention provides computer software embodied in a propagated signal for implementing an application for processing organizational roles with a graphical user interface that can manipulate graphical role data, the computer software comprising instructions to cause a computer to perform the following functions: allow a user to graphically define roles in an organization; allow a user to graphically define relationships among the roles in the organization; and allow a user to graphically assign rights to different roles in the organization.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a computer system having an identity management system in accordance with the present invention.

FIG. 2 depicts an illustrative graphical user interface from the identity management system of FIG. 1.

### DETAILED DESCRIPTION OF THE INVENTION

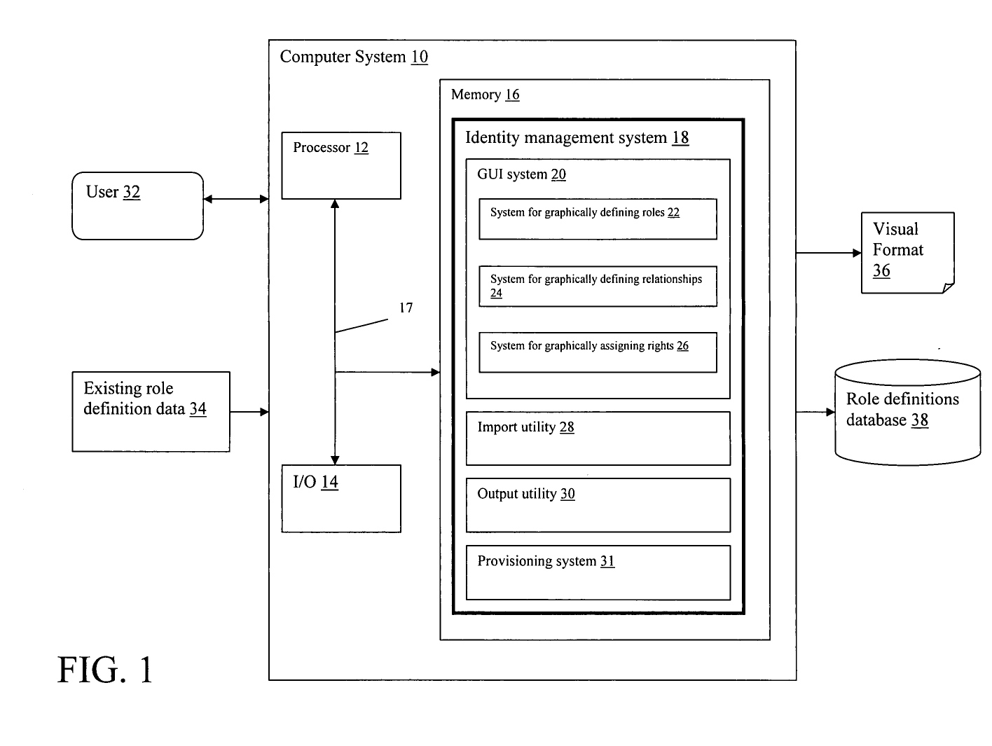

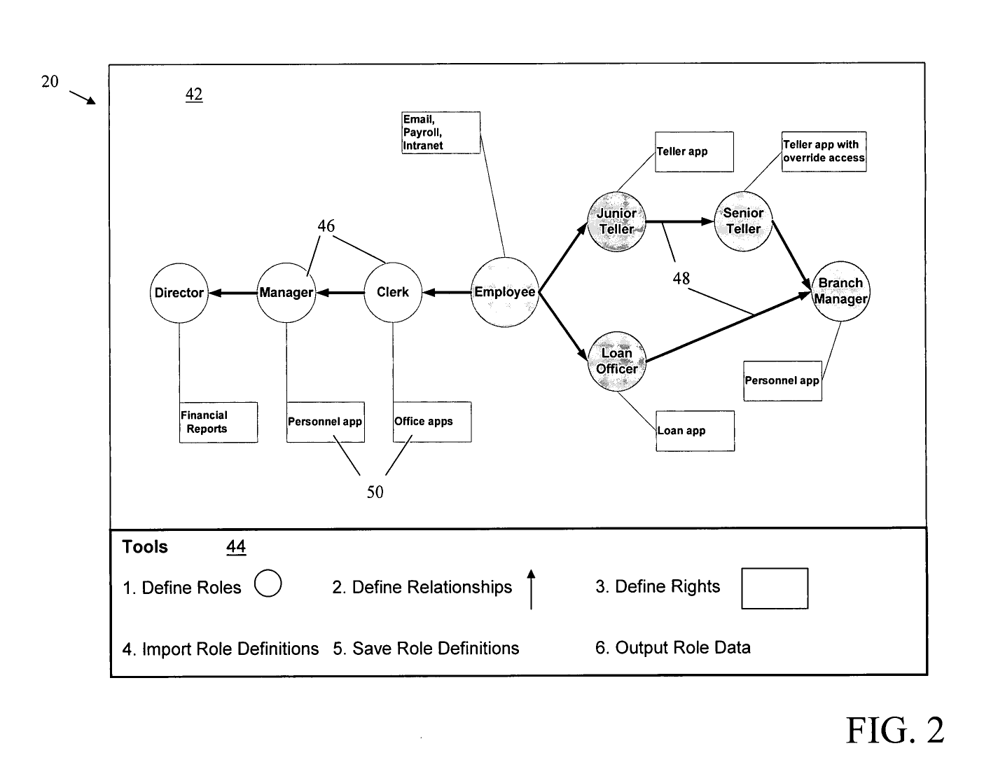

Referring now to drawings, FIG. 1 depicts a computer system 10 having an identity management system 18 for processing role data to determine access control rights for employees of an organization. Identity management system 18 includes a graphical user interface (GUI) system 20, which allows a user 32 to graphically display and manipulate role data. Access control rights for information within an organization are based on roles defined within the organization, which are defined/manipulated using GUI system 20. The GUI system 20 simplifies the process of entering roles and associated access rights by utilizing a graphical mind mapping front end described below with reference to FIG. 2. Graphical role data can be generated in any number of ways, e.g., imported from existing role definition data 34, loaded from a role definitions database 38, or created within GUI system 20.

Existing role definition data 34 and/or role data stored in a role definitions database 38 can be loaded into the identity management system 18 with an import utility 28 that converts standard data definition formats, e.g., LDIF files, DSML files, WORD™ files, POWERPOINT™ files, etc., into a graphical format. Once generated, graphical role data can be output using output utility 30 in a visual format 36, e.g., in the form of printed graphical maps, as hierarchical outlines in a document, as an electronic image, etc. Alternatively, output utility 30 could generate a formatted data file, e.g., using LDIF or DSML definitions, as a WORD or PDF file, etc. In this case, the output could then be fed into: (1) a directory, e.g., stored in role definitions database 38; or (2) a provisioning system 31, which could automatically implement access control rights for the organization.

GUI system 20 includes a system for graphically defining roles 22, a system for graphically defining relationships 24, and a system for graphically assigning rights 26. FIG. 2 depicts an example of a GUI system 20 that includes: (1) a design window 42 for processing/displaying graphical data as a mind-map; and (2) a tools window 44 that provides a set of tools and utilities for creating/processing the graphical role data. In the example of FIG. 2, design window 42 displays a set of graphical role data (i.e., a mind map) that includes roles 46, relationships 48, and rights 50. Roles 46 are shown as nodes in a tree-like structure, which are connected by arrows that define the relationships 48 among the roles 46. Boxes or pop-up windows are used to define the rights 50 given to each role. Rights 50 are inherited from one role to another based on the defined relationships 48. More specifically, inheritance of rights is depicted via arrows that indicate the direction that rights are accumulated.

In the example shown, the center node “Employee” is given the rights “Email, Payroll, and Intranet.” These rights are inherited by each of the other roles in the mind map. For instance, as shown by the arrows, the “Clerk” role inherits all rights that are given to the Employee role, the “Manager” role inherits all rights given to the Clerk role, and the “Director” role inherits all rights given to the Manager role. As can be seen, the Clerk role is also given the rights to “Office apps,” which are inherited by the Manger role and Director role. Similarly, the Manager role is given the rights to “Personnel app,” which is inherited by the Director role. Finally, the Director role is given the rights to “Financial Reports,” which not inherited by any other role. A similar structure is provided on the right side of the Employee node in which the Branch Manager role inherits rights along two paths, namely from along a Senior Teller/Junior Teller/Employee path and from along a Loan Officer/Employee path. Accordingly, the user is able to provide inheritance rules to a set of roles in a hierarchical fashion.

Using a mouse and keyboard, the user is able to select tools 44 and/or manipulate the circles, arrows and boxes in the design window 42 to create and modify roles, relationships and rights. In addition, the user can import role definitions into the design window 42 from existing role definition data 34, save role definitions to a role definitions database 38, and output graphical role data in a visual format 36. Obviously, the specific graphical format of the role data in design window 42 and tools 44 can differ from what is shown without departing from the scope of invention.

In general, computer system 10 shown in FIG. 1 may comprise any type of computing system that includes a graphical display, e.g., a desktop, a laptop, a handheld device, etc. Moreover, computer system 10 could be implemented as part of a client and/or a server. Computer system 10 generally includes a processor 12, input/output (I/O) 14, memory 16, and bus 17. The processor 12 may comprise a single processing unit, or be distributed across one or more processing units in one or more locations, e.g., on a client and server. Memory 16 may comprise any known type of data storage and/or transmission media, including magnetic media, optical media, random access memory (RAM), read-only memory (ROM), a data cache, a data object, etc. Moreover, memory 16 may reside at a single physical location, comprising one or more types of data storage, or be distributed across a plurality of physical systems in various forms.

I/O 14 may comprise any system for exchanging information to/from an external resource. External devices/resources may comprise any known type of external device, including a monitor/display, speakers, storage, another computer system, a hand-held device, keyboard, mouse, voice recognition system, speech output system, printer, facsimile, pager, etc. Bus 17 provides a communication link between each of the components in the computer system 10 and likewise may comprise any known type of transmission link, including electrical, optical, wireless, etc. Although not shown, additional components, such as cache memory, communication systems, system software, etc., may be incorporated into computer system 10.

Access to computer system 10 may be provided over a network such as the Internet, a local area network (LAN), a wide area network (WAN), a virtual private network (VPN), etc. Communication could occur via a direct hardwired connection (e.g., serial port), or via an addressable connection that may utilize any combination of wireline and/or wireless transmission methods. Moreover, conventional network connectivity, such as Token Ring, Ethernet, WiFi or other conventional communications standards could be used. Still yet, connectivity could be provided by conventional TCP/IP sockets-based protocol. In this instance, an Internet service provider could be used to establish interconnectivity. Further, as indicated above, communication could occur in a client-server or server-server environment.

It should also be appreciated that the teachings of the present invention could be offered as a business method on a subscription or fee basis. For example, a computer system 10 comprising an identity management system 18 having a GUI system 20 could be created, maintained and/or deployed by a service provider that offers the functions described herein for customers. That is, a service provider could offer to provide an online visual identity management system as described above.

It is understood that the systems, functions, mechanisms, methods, engines and modules described herein can be implemented in hardware, software, or a combination of hardware and software. They may be implemented by any type of computer system or other apparatus adapted for carrying out the methods described herein. A typical combination of hardware and software could be a general-purpose computer system with a computer program that, when loaded and executed, controls the computer system such that it carries out the methods described herein. Alternatively, a specific use computer, containing specialized hardware for carrying out one or more of the functional tasks of the invention could be utilized. In a further embodiment, part of all of the invention could be implemented in a distributed manner, e.g., over a network such as the Internet.

The present invention can also be embedded in a computer program product, which comprises all the features enabling the implementation of the methods and functions described herein, and which—when loaded in a computer system—is able to carry out these methods and functions. Terms such as computer program, software program, program, program product, software, etc., in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

1. An identity management system having a graphical user interface for manipulating graphical role data, comprising:
a system for graphically defining roles in an organization;
a system for graphically defining relationships among the roles in the organization; and
a system for graphically assigning rights to different roles in the organization.

2. The identity management system of claim 1, wherein the identity management system further includes an import utility that imports role definition data and converts the role definition data into graphical role data that can be manipulated by the graphical user interface.

3. The identity management system of claim 1, wherein the graphical role data depicts a set of roles as nodes in a tree-like structure.

4. The identity management system of claim 1, wherein the system for graphically defining relationships among the roles in the organization determines what rights are to be inherited from a first role to second role.

5. The identity management system of claim 4, wherein the system for graphically defining relationships among the roles in the organization utilizes arrows to establish inheritance rules.

6. The identity management system of claim 1, further comprising an output utility for outputting graphical data in a visual format, and for outputting role definitions in a predefined format.

7. The identity management system of claim 6, further comprising a provisioning system that implements access control rights for an organization based on outputted role definitions.

8. A computer program product stored on a computer usable medium for processing organizational roles with a graphical user interface that can manipulate graphical role data, comprising:
program code configured to allow a user to graphically define roles in an organization;
program code configured to allow a user to graphically define relationships among the roles in the organization; and
program code configured to allow a user to graphically assign rights to different roles in the organization.

9. The computer program product of claim 8, further comprising program code configured to import role definition data and convert the role definition data into graphical role data that can be manipulated by the graphical user interface.

10. The computer program product of claim 8, wherein the graphical role data depicts a set of roles as nodes in a tree-like structure.

11. The computer program product of claim 8, wherein graphically defined relationships among the roles in the organization determine what rights are to be inherited from a first role to second role.

12. The computer program product of claim 11, wherein the graphically defined relationships are implemented utilizing arrows to establish inheritance rules.

13. The computer program product of claim 8, further comprising program code configured for outputting graphical data in a visual format, and for outputting role definitions in a predefined format.

14. The computer program product of claim 13, further comprising program code configured for implementing access control rights for an organization based on outputted role definitions.

15. A method for processing organizational roles with a graphical user interface (GUI) that can manipulate graphical role data, comprising:
graphically defining roles in an organization as nodes in a tree-like structure;
graphically defining relationships among the roles in the organization with arrows; and
graphically assigning rights to different roles in the organization.

16. The method of claim 15, comprising the initial steps of importing role definition data and converting the role definition data into graphical role data that can be manipulated by the graphical user interface.

17. The method of claim 15, wherein the arrows determine what rights are to be inherited from a first role to second role.

18. The method of claim 15, comprising the further step of outputting graphical data in a visual format.

19. The method of claim 15, comprising the further step of outputting role definitions in a predefined format.

20. The method of claim 19, comprising the further step of implementing access control rights for an organization based on outputted role definitions.

21. A method for deploying an application for processing organizational roles with a graphical user interface that can manipulate graphical role data, comprising:
providing a computer infrastructure being operable to:
allow a user to graphically defining roles in an organization;
allow a user to graphically defining relationships among the roles in the organization; and
allow a user to graphically assigning rights to different roles in the organization.
